(19) United States
(12) Patent Application Publication
(10) Pub. No.: US 2026/0163162 A1
(43) Pub. Date: Jun. 11, 2026

(54) POWER STORAGE APPARATUS

(71) Applicant: TOYOTA JIDOSHA KABUSHIKI KAISHA, Toyota-shi (JP)

(72) Inventor: Toshio UCHIYAMA, Toyota-shi (JP)

(73) Assignee: TOYOTA JIDOSHA KABUSHIKI KAISHA, Toyota-shi (JP)

(21) Appl. No.: 19/182,183

(22) Filed: Apr. 17, 2025

(30) Foreign Application Priority Data
May 15, 2024 (JP) 2024-079168

(51) Int. Cl. H01M 50/291; H01M 50/367

(52) U.S. Cl. CPC H01M 50/291; H01M 50/367

(57) ABSTRACT

The storage battery cell unit includes a lower battery module including a plurality of battery cells, an upper battery module including a plurality of battery cells, a battery module case for housing the lower battery module and the upper battery module, and an upper battery module floor configured to divide an internal space of the battery module case into an upper housing space for housing the upper battery module and the lower housing space for housing the lower battery module. A gap is formed in the upper battery module floor for releasing gas generated in one of the upper housing spaces or the lower housing space to the other one of the housing spaces.

### CROSS REFERENCE TO RELATED APPLICATIONS

This application is based upon and claims the benefit of priority from Japanese patent application No. 2024-079168, filed on May 15, 2024, the disclosure of which is incorporated herein in its entirety by reference.

### BACKGROUND

The present disclosure relates to a power storage apparatus. Patent Literature 1 discloses a support structure of a battery module laminated in two stages in the vertical direction.

Patent Literature 1: Japanese Unexamined Patent Application Publication No. 2014-099257

### SUMMARY

When a discharge product is discharged from a safety valve of a battery cell included in a battery module disposed in the lower stage, it is sometimes impossible to promptly diffuse the discharge product within a case.

An object of the present disclosure is to provide a technique for promptly diffusing gas generated from an upper battery module or a lower battery module within a case.

Provided is a power storage apparatus, including: a lower battery module including a plurality of battery cells; an upper battery module including a plurality of battery cells; a case for housing the lower battery module and the upper battery module; and a partition plate configured to divide an internal space of the case into an upper housing space for housing the upper battery module and a lower housing space for housing the lower battery module, in which a gas flow channel is formed in the partition plate for releasing gas generated in one of the upper housing space or the lower housing space to the other one of the housing spaces. With the above configuration, since gas generated in one of the upper housing space or the lower housing space can be released to the other one of the housing spaces, gas generated from the upper battery module or the lower battery module can be promptly diffused within the case.

The partition plate may include a plurality of cylindrical bodies extending parallel to each other. With the above configuration, the rigidity of the partition plate can be enhanced.

The partition plate is configured to project outside the upper battery module and the lower battery module in a planar view. With the above configuration, since the upper battery module floor can absorb impact acting on the battery module case from the side, the upper battery module 2a and the lower battery module 2b can be effectively protected from impact.

The power storage apparatus further includes a pressure release valve provided in the case, in which the pressure release valve is arranged at a position higher than that of the partition plate. With the above configuration, gas in the case can be released from a higher position than in a configuration in which the pressure release valve is arranged at a position lower than the partition plate.

The power storage apparatus further includes an electronic device, in which the electronic device is arranged between the upper battery module and the pressure release valve in a planar view. The above configuration contributes to size reduction of the power storage apparatus.

According to the present disclosure, gas generated from an upper battery module or a lower battery module can be promptly diffused within the case.

The above and other objects, features and advantages of the present disclosure will become more fully understood from the detailed description given hereinbelow and the accompanying drawings.

### BRIEF DESCRIPTION OF DRAWINGS

FIG. 1 is a cross-sectional view of a storage battery cell unit;

FIG. 2 is another cross-sectional view of the storage battery cell unit; and

FIG. 3 is a plan sectional view of the storage battery cell unit.

### DESCRIPTION OF EMBODIMENTS

Hereinafter, the present disclosure will be described through embodiments of the disclosure, but the claimed disclosure is not limited to the following embodiments. In addition, all of the configurations described in the embodiments are not necessarily essential as means to solve the problem. For clarity of explanation, the following descriptions and drawings are omitted and simplified as appropriate. In each of the drawings, the same reference numerals are assigned to the same elements, and duplicate descriptions are omitted where necessary.

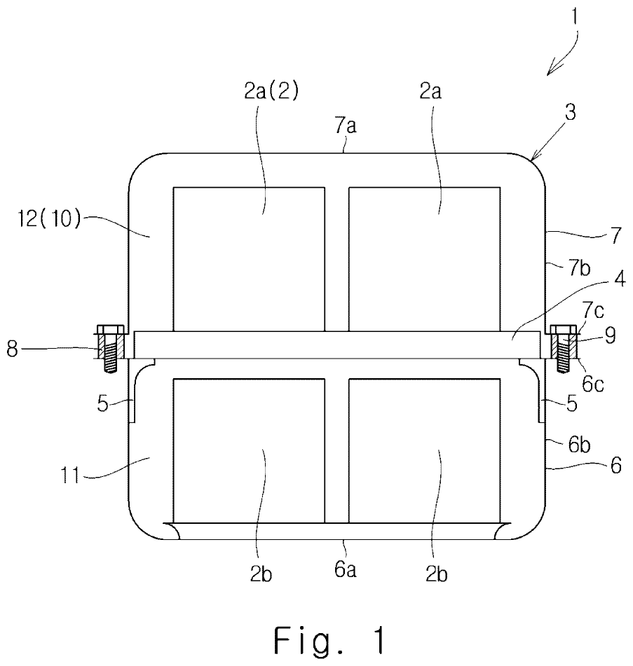

FIG. 1 shows a cross-sectional view of a storage battery cell unit 1. The storage battery cell unit 1 is a specific example of a power storage apparatus. As an example, the storage battery cell unit 1 is incorporated into a residential stationary storage battery system. A residential stationary storage battery system is usually installed in a narrow space between a house and a boundary of an adjacent land. Therefore, the size of the storage battery cell unit 1, which is especially large among the components of a residential stationary storage battery system, needs to be reduced. In order to reduce the size of the storage battery cell unit 1, a multi-stage configuration in which a plurality of battery modules 2 of the storage battery cell unit 1 are stacked in the vertical direction is typically adopted.

As shown in FIG. 1, the plurality of the battery modules 2 include two upper battery modules 2a and two lower battery modules 2b. The number of the upper battery modules 2a may be one or three or more. The number of the lower battery modules 2b may be one or three or more. The storage battery cell unit 1 includes the plurality of the battery modules 2, a battery module case 3, an upper battery module floor 4, and a bracket 5. The battery module case 3 is a specific example of a case. The upper battery module floor 4 is a specific example of a partition plate.

The battery module case 3 houses a plurality of the battery modules 2. The battery module case 3 includes a lower case 6 and an upper case 7.

The lower case 6 is configured in a bottomed box shape opening upward. The lower case 6 includes a rectangular-tube shaped wall 6b, having an annular shape in a planar view and configured to project upward from a bottom part 6a and the periphery of the bottom part 6a, and a flange 6c, having an annular shape and configured to project outward from the upper end of the rectangular-tube shaped wall 6b in a planar view.

The upper case 7 is configured in a bottomed box shape opening downward. The upper case 7 includes a rectangular-tube shaped wall 7b, having an annular shape in a planar view and configured to project downward from a bottom part 7a and the periphery of the bottom part 7a, and a flange 7c, having an annular shape and configured to project outward from the lower end of the rectangular-tube shaped wall 7b in a planar view.

The flange 6c and the flange 7c are connected to each other by bolting, typically by a plurality of bolts 9, in a state of being arranged so as to face each other vertically across a gasket 8.

A plurality of the brackets 5 are fixed to the inner surface of the rectangular-tube shaped wall 6b of the lower case 6. The upper battery module floor 4 is fixed to the plurality of the brackets 5, typically by bolting. Thus, the upper battery module floor 4 is supported by the lower case 6 via the plurality of the brackets 5.

By providing the upper battery module floor 4 in the battery module case 3, an internal space 10 in the battery module case 3 is divided into a space defined by a lower housing space 11 formed at a position lower than the upper battery module floor 4, and a space defined by an upper housing space 12 formed at a position higher than that of the upper battery module floor 4. In the lower housing space 11, two lower battery modules 2b are adjacently arranged in the horizontal direction. In the upper housing space 12, two upper battery modules 2a are adjacently arranged in the horizontal direction. As a result, the plurality of the lower battery modules 2b and the plurality of the upper battery modules 2a are vertically arranged across the upper battery module floor 4. The two upper battery modules 2a are arranged at positions higher than those of the two lower battery modules 2b. The two upper battery modules 2a and the two lower battery modules 2b are arranged so as to face each other vertically across the upper battery module floor 4. The two upper battery modules 2a are supported by the upper battery module floor 4. The two lower battery modules 2b are supported by the bottom part 6a of the lower case 6.

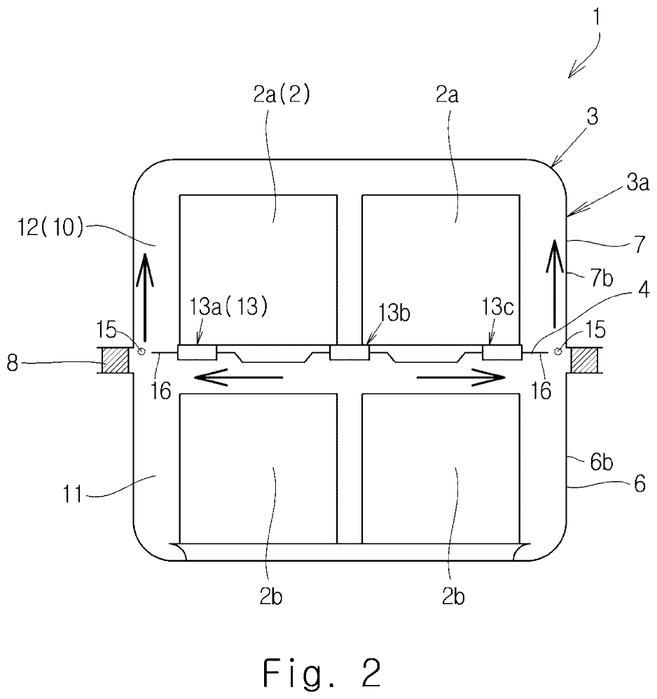

FIG. 2 shows another cross-sectional view of the storage battery cell unit 1. The cross-sectional view shown in FIG. 2 shows a cross-sectional view parallel to the cross-sectional view shown in FIG. 1. In the cross-sectional view shown in FIG. 2, the storage battery cell unit 1 is cut at cross section where there are no plurality of brackets 5 present.

As shown in FIG. 2, the upper battery module floor 4 is bent in a corrugated shape in cross section to ensure rigidity. Furthermore, the upper battery module floor 4 includes a plurality of cylindrical bodies 13 extending parallel to each other. The plurality of the cylindrical bodies 13 extend horizontally. A part of the upper battery module floor 4 is configured by the plurality of the cylindrical body bodies 13. The plurality of the cylindrical bodies 13 include, for example, three cylindrical bodies 13. The three cylindrical bodies 13 include a first cylindrical body 13a, a second cylindrical body 13b, and a third cylindrical body 13c. The first cylindrical body 13a, the second cylindrical body 13b, and the third cylindrical body 13c are arranged in this order. One of the two upper battery modules 2a is mounted on the first cylindrical body 13a and the second cylindrical body 13b, and the other one of the upper battery modules 2a is mounted on the second cylindrical body 13b and the third cylindrical body 13c.

The upper battery module floor 4 is configured to project outside the plurality of battery modules 2 in a planar view. In other words, the upper battery module floor 4 includes an outward projection part 16 extending annularly so as to surround the plurality of the battery modules 2 in a planar view. In other words, the outward projection part 16 is configured to project in a direction away from the plurality of the battery modules 2 in a planar view. For example, in the direction in which the two upper battery modules 2a are arranged in a planar view, the outward projection part 16 is configured to project on the opposite side of the two upper battery modules 2a across one of the two upper battery modules 2a, that is, configured to project on the opposite side of one of the two upper battery modules 2a across the other one of the upper battery modules 2a. The outward projection part 16 is arranged between a peripheral wall 3a of the battery module case 3 and the plurality of the battery modules 2. Since the upper battery module floor 4 includes the outward projection part 16, when an impact acts on the battery module case 3 from the side thereby causing the peripheral wall 3a of the battery module case 3 to deform inward, the outward projection part 16 actively buckles and deforms to absorb the impact, thereby suppressing the action of impact on the plurality of battery modules 2.

A gap 15 is formed in the upper battery module floor 4. In this embodiment, the gap 15 is formed between the upper battery module floor 4 and the peripheral wall 3a of the battery module case 3. However, instead of this, the gap 15 may be at least one hole formed in the upper battery module floor 4 itself. The gap 15 is a specific example of a gas flow channel. Owing to the presence of the gap 15, gas generated from the upper battery module 2a in the upper housing space 12 can be released to the lower housing space 11. Similarly, gas generated from the lower battery module 2b in the lower housing space 11 can be released to the upper housing space 12 owing to the presence of the gap 15. The upper battery module floor 4 completely covers the lower surfaces of the two upper battery modules 2a. Therefore, gas generated from the lower battery module 2b does not directly hit the upper battery module 2a. Therefore, gas generated from the lower battery module 2b directly hits the upper battery module 2a, heats the upper battery module 2a, and suppresses further generation of gas from the upper battery module 2a. The gas generated from the lower battery module 2b flows outward in a planar view by hitting the upper battery module floor 4 as indicated by the thick arrow in FIG. 2, and then reaches the gap 15, and then enters the upper housing space 12 through the gap 15. Thus, the gas generated from the lower battery module 2b is diffused inside the battery module case 3 without directly hitting the upper battery module 2a, and heat is radiated within the battery module case 3 and the internal space 10, thereby the temperature of the gas itself is lowered. As the temperature of the gas lowers, pressure rise in the internal space 10 of the battery module case 3 is alleviated.

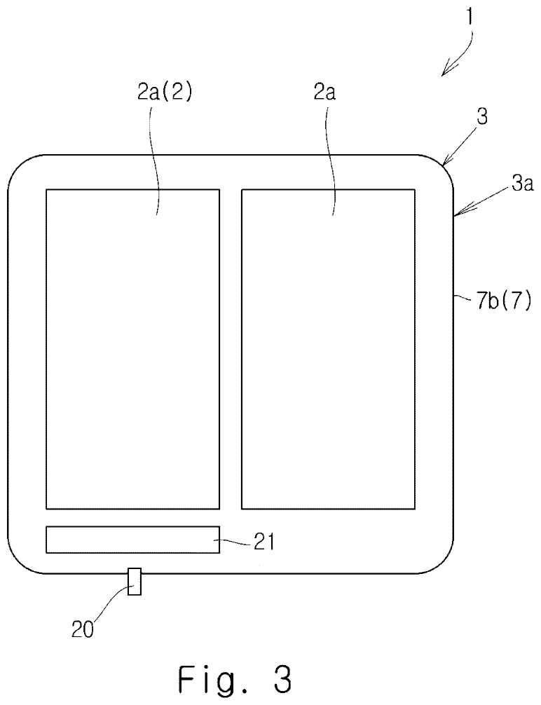

FIG. 3 is a plan sectional view of the storage battery cell unit 1. As shown in FIG. 3, the rectangular-tube shaped wall 7b of the upper case 7 is provided with a pressure release valve 20. In the case where the pressure in the battery module case 3 exceeds a predetermined value, the pressure release valve 20 suppresses pressure rise in the battery module case 3 by releasing the gas in the battery module case 3 to the outside of the battery module case 3. Furthermore, the pressure release valve contributes to safety when the gas is discharged from the battery module case 3 via the pressure release valve 20.

As shown in FIG. 3, the storage battery cell unit 1 further includes an electronic device 21. The electronic device 21 is typically, but is not limited to, a control board of the storage battery cell unit 1. In the planar view shown in FIG. 3, the electronic device 21 is arranged between the upper battery module 2a and the pressure release valve 20. Thus, the storage battery cell unit 1 is reduced in size in the height direction.

The above-described preferred embodiment of the present disclosure has the following features.

The storage battery cell unit 1 (a power storage apparatus) includes the lower battery module 2b including a plurality of battery cells, the upper battery module 2a including a plurality of battery cells, the battery module case 3 (a case) for housing the lower battery module 2b and the upper battery module 2a, and the upper battery module floor 4 (a partition plate) configured to divide the internal space 10 of the battery module case 3 into the upper housing space 12 for housing the upper battery module 2a and the lower housing space 11 for housing the lower battery module 2b. The gap 15 (a gas flow channel) is formed in the upper battery module floor 4 for allowing gas generated in one of the upper housing space 12 or the lower housing space 11 to be released to the other one of the housing spaces. With the above configuration, since gas generated in one of the upper housing space 12 or the lower housing space 11 can be released to the other one of the housing spaces, gas generated from the upper battery module 2a or the lower battery module 2b can be promptly diffused in the case.

As shown in FIG. 2, the upper battery module floor 4 includes the plurality of the cylindrical bodies 13 extending in parallel with each other. With the above configuration, the rigidity of the upper battery module floor 4 can be effectively enhanced.

Also, as shown in FIG. 2, the upper battery module floor 4 is configured to project outside the upper battery module 2a and the lower battery module 2b in a planar view. With the above configuration, since the upper battery module floor 4 can absorb an impact acting on the battery module case 3 from the side, the upper battery module 2a and the lower battery module 2b can be effectively protected from an impact.

Also, as shown in FIG. 3, the storage battery cell unit 1 further includes the pressure release valve 20 provided in the battery module case 3. The pressure release valve 20 is arranged at a position higher than that of the upper battery module floor 4. With the above configuration, gas in the battery module case 3 can be released from a higher position than in a configuration in which the pressure release valve 20 is arranged at a position lower than the upper battery module floor 4.

As shown in FIG. 3, the storage battery cell unit 1 further includes the electronic device 21. The electronic device 21 is arranged between the upper battery module 2a and the pressure release valve 20 in a planar view. The above configuration contributes to size reduction of the storage battery cell unit 1.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A power storage apparatus, comprising:
a lower battery module including a plurality of battery cells;
an upper battery module including a plurality of battery cells;
a case for housing the lower battery module and the upper battery module; and
a partition plate configured to divide an internal space of the case into an upper housing space for housing the upper battery module and a lower housing space for housing the lower battery module,
wherein a gas flow channel is formed in the partition plate for releasing gas generated in one of the upper housing space or the lower housing space to the other one of the housing spaces.

2. The power storage apparatus according to claim 1, wherein the partition plate includes a plurality of cylindrical bodies extending parallel to each other.

3. The power storage apparatus according to claim 1, wherein the partition plate is configured to project outside the upper battery module and the lower battery module in a planar view.

4. The power storage apparatus according to claim 1, further comprising a pressure release valve provided in the case,
wherein the pressure release valve is arranged at a position higher than that of the partition plate.

5. The power storage apparatus according to claim 4, further comprising an electronic device,
wherein the electronic device is arranged between the upper battery module and the pressure release valve in a planar view.
